(19) United States
(12) Patent Application Publication
(10) Pub. No.: US 2006/0291218 A1
(43) Pub. Date: Dec. 28, 2006

(54) Light fixtures and methods for directionally controlling light emissions

(76) Inventor: Bruce Raymond Pazula, Broadview Heights, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/475,849

(22) Filed: Jun. 27, 2006

Related U.S. Application Data
(60) Provisional application No. 60/694,283, filed on Jun. 27, 2005.

(51) Int. Cl. F21S 13/10

(52) U.S. Cl. 362/367

(57) ABSTRACT

A lighting fixtures are provided. An exemplary fixture may include a housing, a light source disposed in a lower portion of the housing, an opaque wall positioned in the housing to provide at least a partial upper boundary for the lower portion, and a decorative ornament, disposed within the housing. The light source is configured to direct light at least partially downward from the lower portion of the housing. The opaque wall prevents light directed from the light source from being emitted outside the housing above a horizontal plane intersecting a lowermost point on the fixture from which light is emitted. The decorative ornament is visible from outside the housing. Another exemplary fixture may include both (a) at least one functioning light source that is shielded in such a manner that light rays emitted by the fixture, either directly from the functioning light source and/or indirectly from the fixture, are not projected above an imaginary horizontal plane running through the lowest point on the fixture where light is emitted and (b) at least one non-functioning light source that is visible from at least one side of the fixture.

### CROSS REFERENCE TO RELATED APPLICATIONS

This application claims priority to, and the benefits of, U.S. Provisional Patent Application Ser. No. 60/694,283, filed on Jun. 27, 2005, which is entitled Light Fixture for Directionally Controlling Light Emissions, and which is incorporated herein by reference.

### FIELD OF THE INVENTION

The present invention relates generally to lighting fixtures. More specifically the present invention relates to lighting fixtures capable of controlling the direction of light emitting from the fixture.

### BACKGROUND OF THE INVENTION

As advocacy groups and government entities begin to consider the potential effects of man-made light, recommendations and regulations are beginning to emerge with regard to the manner in which light is emitted from outdoor lighting fixtures. Collectively, these recommendations and regulations can be labeled as “dark sky” regulations. In general, dark sky regulations provide that light rays emitted by outdoor fixtures be projected below a horizontal plane running through the lowest point on the fixture where light is emitted. For example, Dark-Sky Ordinance 90.02 of the City of Tempe, Ariz., has as its express intent “to restrict the permitted use of outdoor artificial illuminating devices emitting undesirable rays into the night sky which have a detrimental effect on astronomical observations” and reads in part with respect to shielding lighting fixtures: “Fully [shielded] shall mean fixtures that are shielded in such a manner that light rays emitted by the fixture, either directly from the lamp or indirectly from the fixture, are projected below a horizontal plane running through the lowest point on the fixture where light is emitted.” Another exemplary dark sky ordinance, the Sandy Dark Sky Ordinance (Ord. 2002-11), defines a “full cutoff fixture” as “A fixture which, as installed, gives no emission of light above a horizontal plane.”

It is known to replace decorative glass panels in decorative lighting fixtures with opaque panels to control the direction of emitted light. However, such modifications may detract from the decorative nature of lighting fixtures and impact the purpose of such fixtures.

### SUMMARY OF THE INVENTION

One aspect of the invention relates to providing a lighting fixture that directs lighting downward in compliance with conventional dark sky regulations, while conveying the aesthetic appearance of a more traditional lighting fixture, such as, for example, a lantern-type lighting fixture.

Exemplary fixtures may include both (a) at least one functioning light source that is shielded in such a manner that light rays emitted by the fixture, either directly from the functioning light source and/or indirectly from the fixture, are not projected above an imaginary horizontal plane running through the lowest point on the fixture where light is emitted and (b) at least one non-functioning light source that is visible from at least one side of the fixture. In exemplary fixtures, the at least one non-functioning light source may be configured with respect to the fixture so that, if the at least one non-functioning light source were functioning, it would cause the fixture, either directly from the light source and/or indirectly from the fixture, to emit light rays above an imaginary horizontal plane running through the lowest point on the fixture where light is emitted.

In one exemplary embodiment, an outdoor lighting fixture is provided. The exemplary fixture includes a housing, a light source disposed in a lower portion of the housing, an opaque wall positioned in the housing to provide at least a partial upper boundary for the lower portion, and a decorative ornament, disposed within the housing. The light source is configured to direct light at least partially downward from the lower portion of the housing. The opaque wall prevents light directed from the light source from being emitted outside the housing above a horizontal plane intersecting a lowermost point on the fixture from which light is emitted. The decorative ornament is visible from outside the housing.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below, serve to exemplify the principles of this invention, wherein:

FIG. 1 is a front view, in partial cross-section, of an exemplary embodiment of a lighting fixture;

FIG. 2 is a side view, in partial cross-section, of the exemplary lighting fixture of FIG. 1;

FIG. 3 is a front view, in partial cross-section, of an exemplary embodiment of a light fixture;

FIG. 4 is a side view, in partial cross-section, of the exemplary lighting fixture of FIG. 3;

FIG. 5 is a front view, in partial cross-section, of an exemplary embodiment of a lighting fixture;

FIG. 6 is a side view, in partial cross-section, of the exemplary lighting fixture of FIG. 5;

FIG. 7 is a front view, in partial cross-section, of an exemplary embodiment of a lighting fixture;

FIG. 8 is a side view, in partial cross-section, of the exemplary lighting fixture of FIG. 7;

FIG. 9 is a front view, in partial cross-section, of an exemplary embodiment of a lighting fixture;

FIG. 10 is a side view, in partial cross-section, of the exemplary lighting fixture of FIG. 9;

FIG. 11 is a front view, in partial cross-section, of an exemplary embodiment of a lighting fixture;

FIG. 12 is a side view, in partial cross-section, of the exemplary lighting fixture of FIG. 11;

FIG. 13 is a front view, in partial cross-section, of an exemplary embodiment of a lighting fixture;

FIG. 14 is a side view, in partial cross-section, of the exemplary lighting fixture of FIG. 13;

FIG. 15 is a front view, in partial cross-section, of an exemplary embodiment of a lighting fixture;

FIG. 16 is a front view, in partial cross-section, of an exemplary embodiment of a lighting fixture;

FIG. 17 is a side exploded view of an exemplary canopy assembly; and

FIG. 18 is a front view, in partial cross-section, of an exemplary embodiment of a lighting fixture.

### DETAILED DESCRIPTION OF THE INVENTION

The present application relates to lighting fixtures adapted to be in accordance with conventional dark sky regulations, which require that any light rays emitted by outdoor fixtures be projected below a horizontal plane running through the lowest point on the fixture from which light is emitted.

According to one aspect of the present invention, a lighting fixture may be provided with a downward directed light source while maintaining the ornamental appearance of a more traditional lighting fixture, such as, for example, a lantern-type lighting fixture. For example, such a lighting fixture may retain the ornamental features of a lantern-type light source, such as a transparent or translucent outer configuration defined by glass panels and/or internal ornamentation resembling light sources, such as candles or light bulbs.

In one embodiment, a lighting fixture includes a lower light source portion separated from an ornamental portion of the fixture by an opaque wall. To comply with conventional dark sky regulations, the light source portion may include one or more light sources configured such that the opaque wall prevents light directed from the one or more light sources from being emitted outside the housing above the lowermost point on the fixture from which light is emitted.

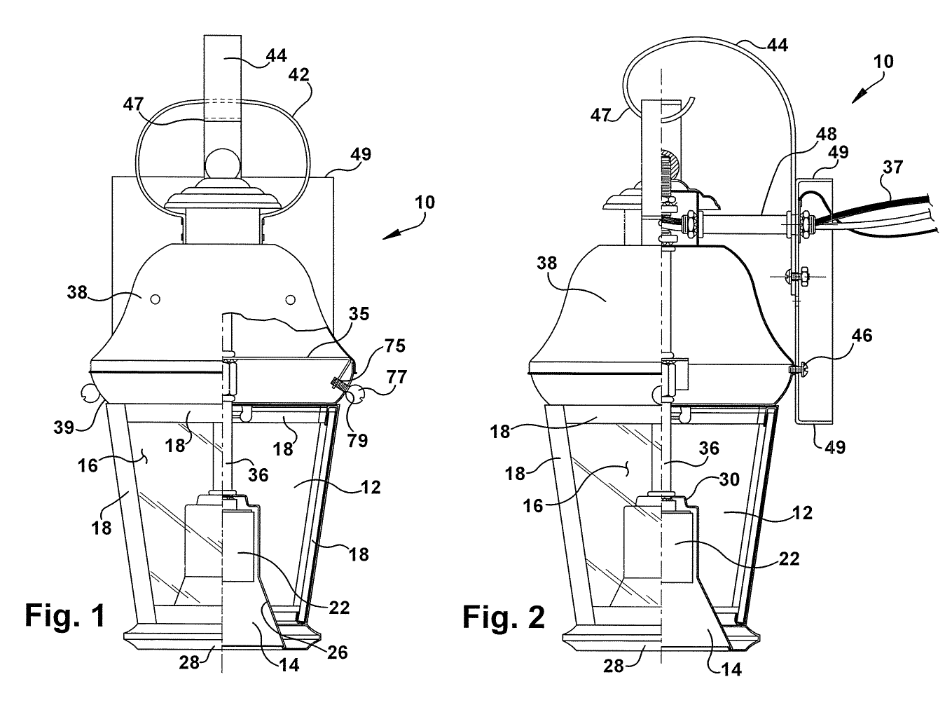

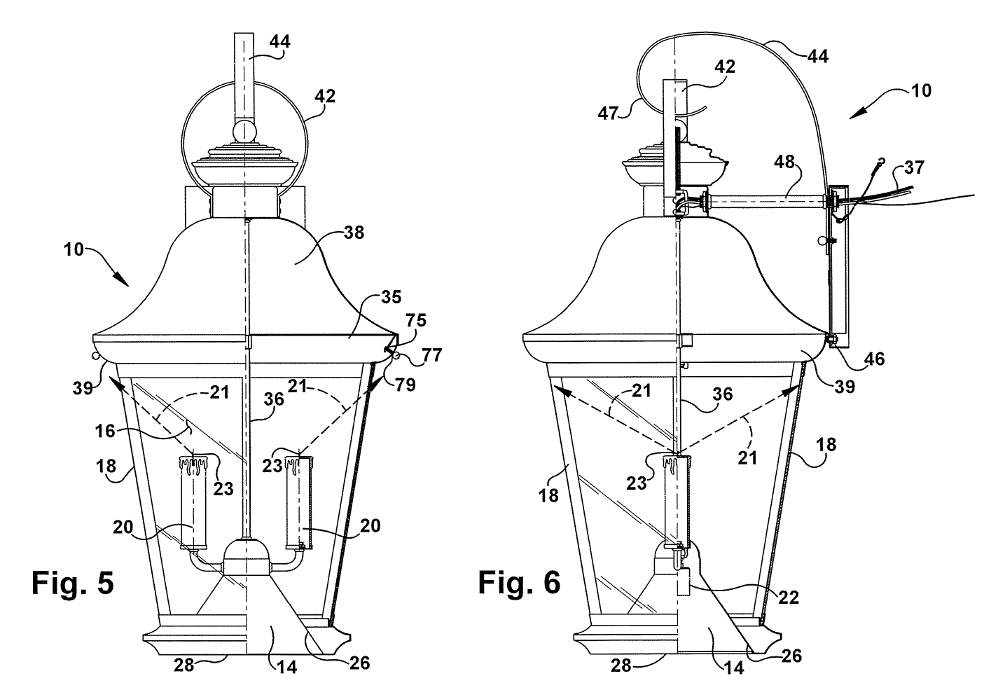

Referring now to the drawings, FIGS. 1-16 illustrate several exemplary embodiments of lighting fixtures according to aspects of the present application.

FIGS. 1 and 2 are front and side views of an exemplary embodiment of a lighting fixture 10. The lighting fixture includes two chambers or portions, a first or decorative portion 12 and a second or lighting or light source portion 14, which extends into the first portion 12. The decorative portion 12 is intended to be aesthetically pleasing and may, but need not, be adapted to resemble a more traditional lighting fixture, such as, for example, a lantern type lighting fixture. Although the intention is to provide decorative features, the first portion 12 may also provide structural integrity for the lighting fixture 10.

Many different configurations may be used to allow internal features of the fixture, both functional and ornamental, to be visible from outside the lighting fixture. Examples include transparent or translucent outer wall portions or an outer wall including openings through which internal features may be visible. In the exemplary embodiment, the decorative chamber 12 is enclosed by a series of glass panels 16 that are coupled together by a series of frame members 18. In alternative embodiments the glass panels 16 and frame members 18 can be replaced by transparent or translucent globes, cylinders, or other such structures to enclose the decorative chamber 12. In still other embodiments, the decorative portion may not be fully enclosed, with frame member providing structural integrity and spaces between the frame members providing visibility of internal features.

The glass panels 16 are intended to allow observers to view the interior of the decorative chamber 12. Although the exemplary illustration includes the use of glass panels 16, the panels may be comprised of any transparent or translucent material that maintains an aesthetically pleasing appearance for the fixture 10. For example the panels may be comprised of frosted or seedy glass.

As shown in the illustrated embodiment of FIGS. 1 and 2, the lack of functional light sources and related electrical components in the decorative chamber 12 results in a substantial enclosed space that is visible through the transparent or translucent side outer wall portion or side glass panels 16. This enclosed space may be left empty, as with the embodiment of FIGS. 1 and 2, with the glass panels 16 and/or the frame members 18 providing the primary decorative features of the decorative portion 12 of the lighting fixture 10. In other embodiments, internal decorative elements may be placed within the decorative portion, to be visible through the glass panels 16. These decorative elements may be included by the manufacturer of the lighting fixture, or they may be added to the decorative chamber later by a retailer or end user.

Many different internal decorative elements may be included within the decorative portion 12 of the lighting fixture 10, made visible through the outer wall portion 16 of the fixture. Examples of such decorative elements include, for example, crystals, pendants, engravings, reflective elements, and pictorial elements. To further the resemblance of the lighting fixture to a more traditional lantern-type lighting fixture, or other such lighting fixture, imitation or non-functioning light sources may be provided within the first portion, thus providing the appearance of a lantern having a light source within the chamber, without emitting light upwardly in contravention of the dark sky regulations. Thus, exemplary fixtures may include both (a) at least one functioning light source that is shielded in such a manner that light rays emitted by the fixture, either directly from the functioning light source and/or indirectly from the fixture, are not projected above an imaginary horizontal plane running through the lowest point on the fixture where light is emitted and (b) at least one non-functioning light source that is visible from outside the fixture from at least one side of the fixture, i.e., left side and/or right side and/or front side and/or back side. In exemplary fixtures, the at least one non-functioning light source and the fixture may be configured so that the non-functioning light source is visible through at least one glass pane. Examples of the at least one non-functioning light source include unlit candles (e.g., imitation candles incapable of being lit and/or real candles that are not lit), non-functioning light bulbs (e.g., imitation light bulbs and/or real light bulbs in an unwired socket or otherwise incapable of illuminating), etc. Also, in exemplary fixtures, the at least one non-functioning light source may be configured with respect to the fixture so that, if the at least one non-functioning light source were functioning as a light source, it would cause the fixture, either directly from the light source and/or indirectly from the fixture, to emit light rays 21 above an imaginary horizontal plane running through the lowest point on the fixture where light would be emitted (e.g., emitted above an imaginary horizontal plane running through the lowest point of the non-functioning light bulb(s) or emitted above an imaginary horizontal plane running through the lowest point of the imaginary flame(s) (FIG. 18) that would extend from imitation candles).

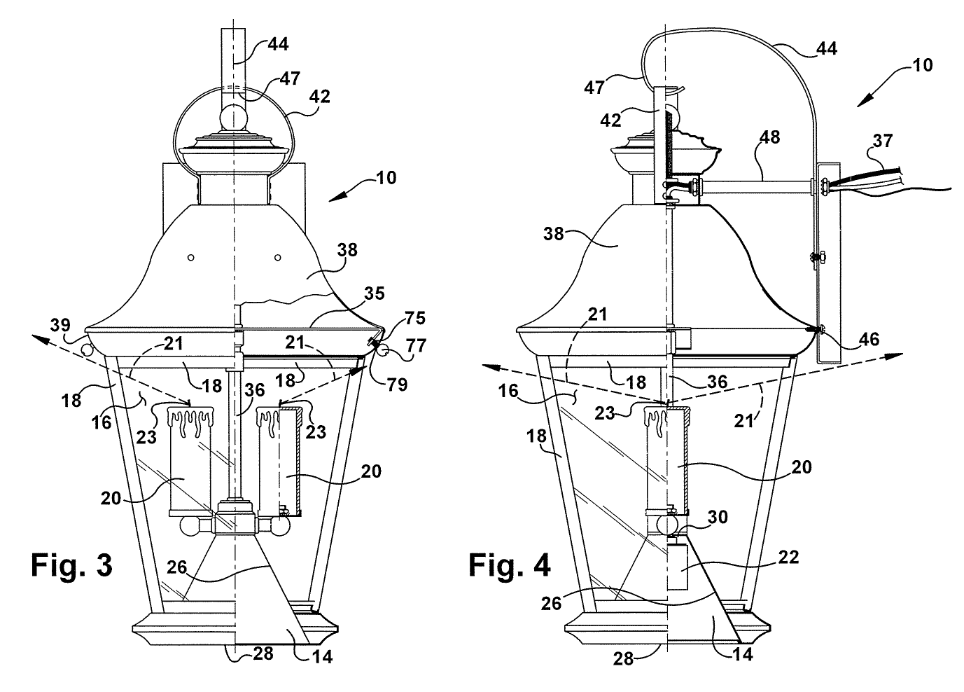

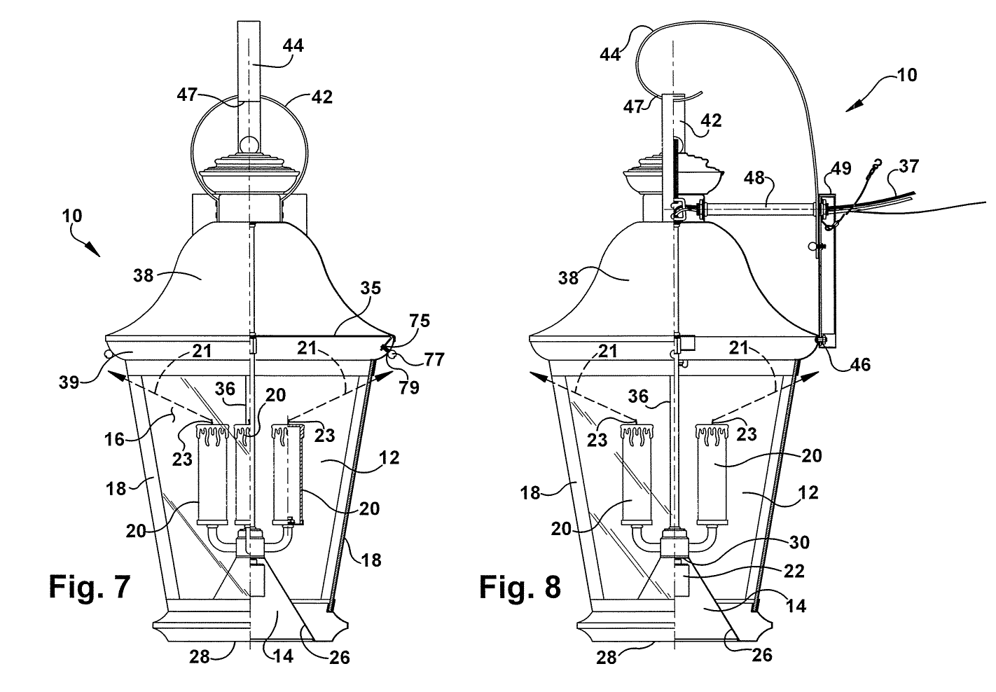

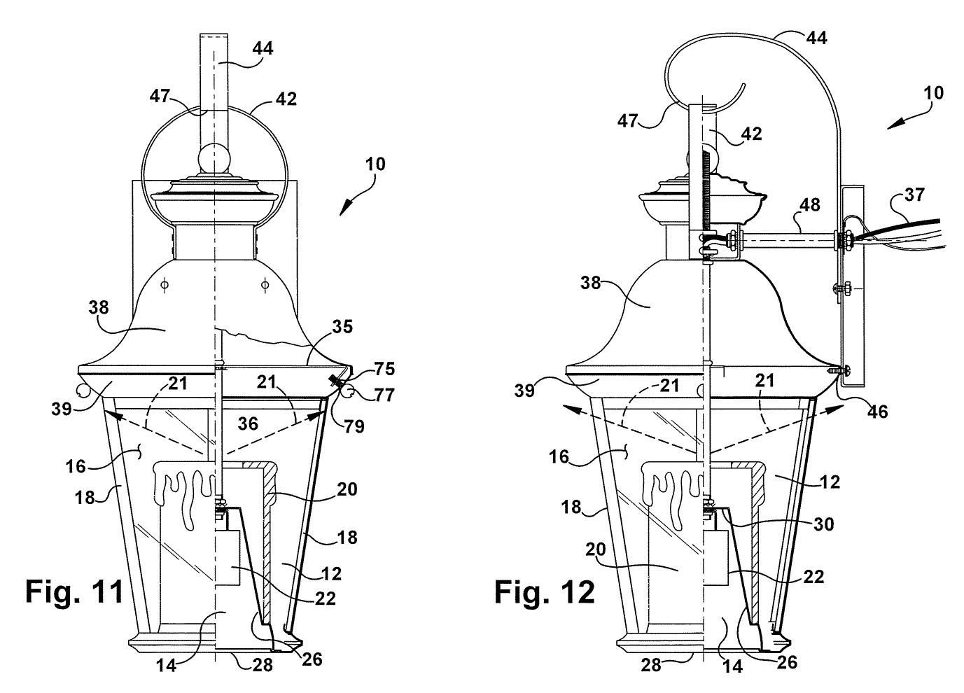

Thus, as illustrated in the exemplary embodiments of FIGS. 3-16, the decorative chamber 12 may include optional imitation lighting sources, such as imitation candles 20. The decorative portion 12 may include any number of imitation light sources. For example, the exemplary embodiments of FIGS. 3-6, 9, 10, 13, 14, and 16 include two imitation candles 20, the exemplary embodiments of FIGS. 7, 8, and 15 include three imitation candles 20, and the exemplary embodiment of FIGS. 11 and 12 includes one imitation candle. Imitation light sources 20 are non-functioning and thus do not emit light. In other embodiments (not shown), unwired sockets may be provided with real or imitation light bulbs in the decorative portion to provide a similar appearance of a traditional light source. In one such exemplary embodiment, the non-functioning light source may be convertible to a functioning light source for use in applications for which the dark sky regulations do not apply. As shown in the exemplary embodiments, the at least one non-functioning light source (candle(s) 20) are configured with respect to the fixture so that, if they were functioning as a light source, it would cause the fixture, either directly from the light source and/or indirectly from the fixture, to emit light rays 21 above an imaginary horizontal plane running through the lowest point on the fixture where light would be emitted (imitation candle(s) 20, if functioning, would emit imaginary light rays 21 from an imaginary flame (FIG. 18), e.g., from imitation wick(s) 23).

Although the embodiments are generally described with transparent or translucent materials enclosing the decorative chamber 12, opaque materials can also be utilized. The purpose of the decorative chamber is to add to the aesthetic nature of the lighting fixture 10. Methods and materials that accomplish this purpose through the use of opaque materials are included in the present invention.

The lighting or light source portion may take many different shapes, positions, and configurations. In one such embodiment, the light source portion extends from a bottom surface of the lighting fixture into the decorative portion of the fixture. The light source portion may include many different types of light sources, including, but not limited to, one or more sockets for incandescent, fluorescent, and/or halogen light bulbs, and light emitting diodes (LED's). According to an aspect of the present invention, an opaque wall at least partially separates the light sources from the decorative portion of the fixture. In one embodiment, the light source or light sources are directed at least partially downward from the opaque wall. In other embodiments, however, one or more light sources may be directed at least partially upward, with the opaque wall reflecting the light rays downward, preventing the lighting fixture from emitting any light rays above the bottom-most light emitting portion of the fixture.

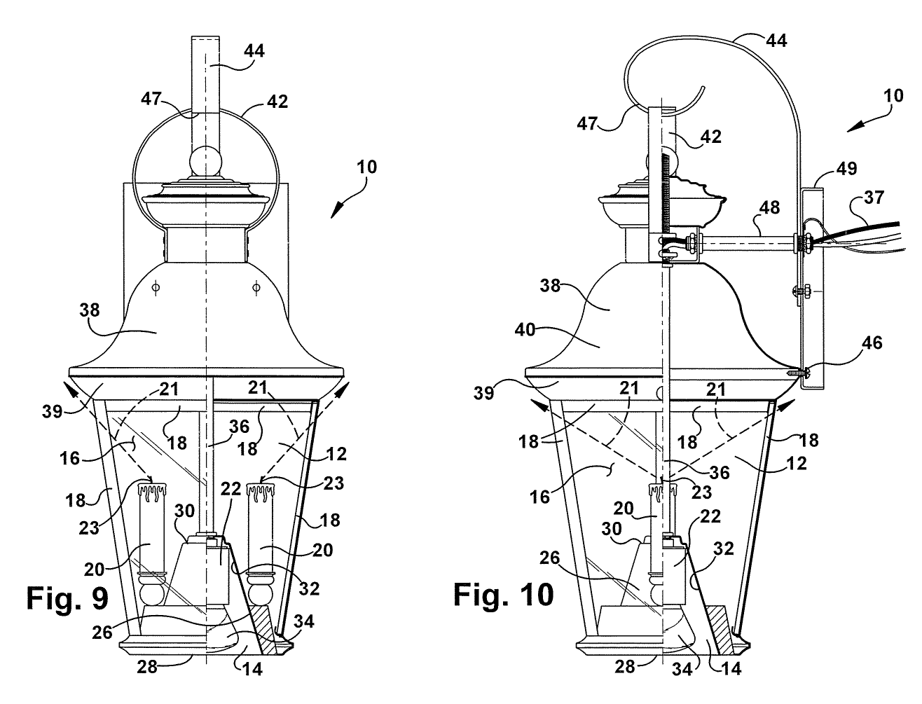

In the illustrated embodiments of FIGS. 1-16, the lighting chamber 14 is disposed at the bottom of the decorative chamber 12. The exemplary lighting chamber or light source portion 14 includes a light bulb socket 22, an internal area capable of containing a light bulb 34 (shown, for example, in FIGS. 9-10), a wall 26 partially enclosing the internal area, and an optically exposed area 28 through which light may be emitted. In the exemplary embodiment, the lighting chamber 14 is shown as generally frustoconical or a truncated conical shape—a cone defined by a conical wall 26 bounded at the top and bottom by parallel planes (shown with a cylindrical portion accepting the base of a bulb in the lighting chamber). The conical wall 26 is constructed of an opaque material which may, but need not be, reflective, and the top plane is enclosed by a top opaque surface 30, which may also be reflective. In providing an optically exposed area, the bottom plane 28 may be either open, enclosed by a transparent or translucent surface, or some combination of these. Although the exemplary embodiment shown and described is a truncated cone (shown with a cylindrical portion accepting the base of a bulb in the lighting chamber), the invention is not limited in any way by the described geometrical shapes, and may include for example, vertical, horizontal, angular, and curvilinear surfaces. Any structure that allows for a light to be directed and emitted from an optically exposed area is contemplated by the invention.

The inner surface 32 of the frustoconical wall 26 and the inner surface of the top surface 30 may include generally reflective material. The reflective material may be utilized to enhance the intensity of light emitted from the lighting chamber 14, or to redirect the light from the light sources 22, 34 in a downward direction. The exemplary light socket 22 is disposed in or near the top surface 30 of the lighting chamber 14. The light socket 22 can be a standard medium base socket, a smaller candelabra socket, or virtually any size or type of socket. A light bulb 34 coupled to the socket 22 will extend into the lighting chamber 14, but will preferably not extend beyond the optically exposed area 28. Weep holes (not shown) may be provided in the lighting fixture, such as in the optically exposed area, to prevent condensation or moisture from accumulating in the decorative or lighting portions of the fixture.

Many different mechanisms or configurations may be utilized to power the light source or light sources in the lighting portion of the fixtures. Examples of such configurations includes a battery or batteries enclosed within the lighting portion and/or the decorative portion of the fixture or electrical wiring extending from the light source through the lighting portion and/or the decorative portion to an external power source. In the illustrated embodiments, a central conduit 36, through which electrical wiring 37 connected to the socket 22 may pass, extends from the top surface 30 of the lighting chamber 14 into and through the decorative chamber 12. Alternatively, the central conduit 36 may be replaced by a conduit extending up the back of the fixture, along a frame member, or within a frame member. In an additional embodiment (not shown), one panel may be an opaque backplate that faces a wall, post, or other mounting surface. In this configuration, the wiring can run along or through the backplate and enter the lighting chamber directly from the backplate.

The wiring 37 to the socket 22 provides power to illuminate a light bulb connected to the socket 22. The lighting chamber 14 is positioned to direct light emitting from the bulb 34 through the optically exposed bottom plane 28. This directs light downward, with respect to FIGS. 1-16. The direction of the light is further facilitated by the reflective surfaces 32 within the lighting chamber 14. As configured, the lighting fixture 10 will not emit light above a horizontal plane running through the lowest point on the fixture from which light is emitted. Maintaining the emission of light below the horizontal plane running through the lowest point on the fixture from which light it emitted would adhere to the general principles that inspire dark sky recommendations and regulations.

In the exemplary embodiment, a decorative cap 38 is disposed at a top end of the decorative chamber 12. The cap 38 may provide structure for securing the lighting fixture 10 to an external structure, such as, for example, a wall, post, roof, or ceiling. Many mechanisms or configurations may be used to attach the cap to the decorative portion 12 of the lighting fixture 10. In the illustrated embodiments, a cross strap 35 is assembled with the central conduit 36. The ends of the cross strap 35 are bent to support the cap 38, and may be welded to the cap 38 to provide additional support. Mounting holes 75 in the strap 35 are positioned to align with corresponding holes 79 in an upper frame member 39 of the decorative portion 12, to receive fasteners 77 to provide a structural connection between the decorative chamber 12, the cap 38 (via the cross strap 35), and the lighting portion 14 (via the conduit 36). Decorative fasteners, such as ball knob studs 77, may be used to provide additional aesthetic appeal.

In connection the light source or light sources to an external power source, the fixture may be configured to provide a wiring connection on many different surfaces or portions of the fixture for many different mounting configurations. In the embodiments of FIGS. 1-12, the fixtures 10 are configured to provide a vertical or wall surface mount. In these exemplary embodiments, the wiring 37 extends from a cap portion 38 of the fixture 10 through a horizontal conduit 48 to a hook member 44 and/or a canopy 49. The canopy 49 may be affixed to a mounting strap for mounting to a wall or other structure. The horizontal conduit 48 may also provide additional structural support between the cap 38 and the canopy 49. The lighting and decorative portions 14, 12 of the fixture 10 may, but need not, be further supported by a fastener 46 attaching the mounting bracket 44 to the base of the cap portion 38.

The top portion 47 of the hook member 44 is formed into the shape of a hook and passes through a handle or strap 42 assembled with the cap 38. The hook member 44 of the embodiments of FIGS. 1-12 is configured to provide the aesthetic appearance of a hanging lantern. However, the top portion 47 may additionally or alternatively provide weight bearing support for added stability to the lighting fixture 10.

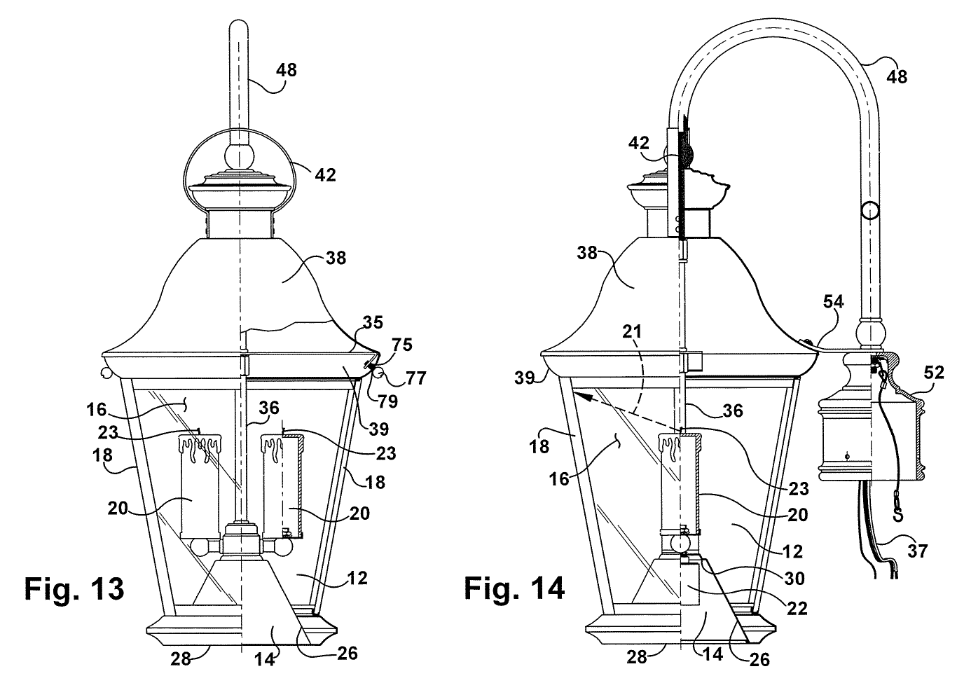

As shown in the embodiment of FIGS. 13 and 14, the fixture 10 may be configured to provide a horizontal or upper surface mount, such as to a roof or upper surface of a wall or post. In this exemplary embodiment, the wiring 37 extends from an upper end of the cap portion 38 through a U-shaped conduit 48, exiting through a post cup 52, which provides for mounting of the fixture 10 to a light post (not shown). The lighting and decorative portions 14, 12 of the fixture 10 may, but need not, be supported by a strap 54 attached to the cap portion 38 and the post cup 52.

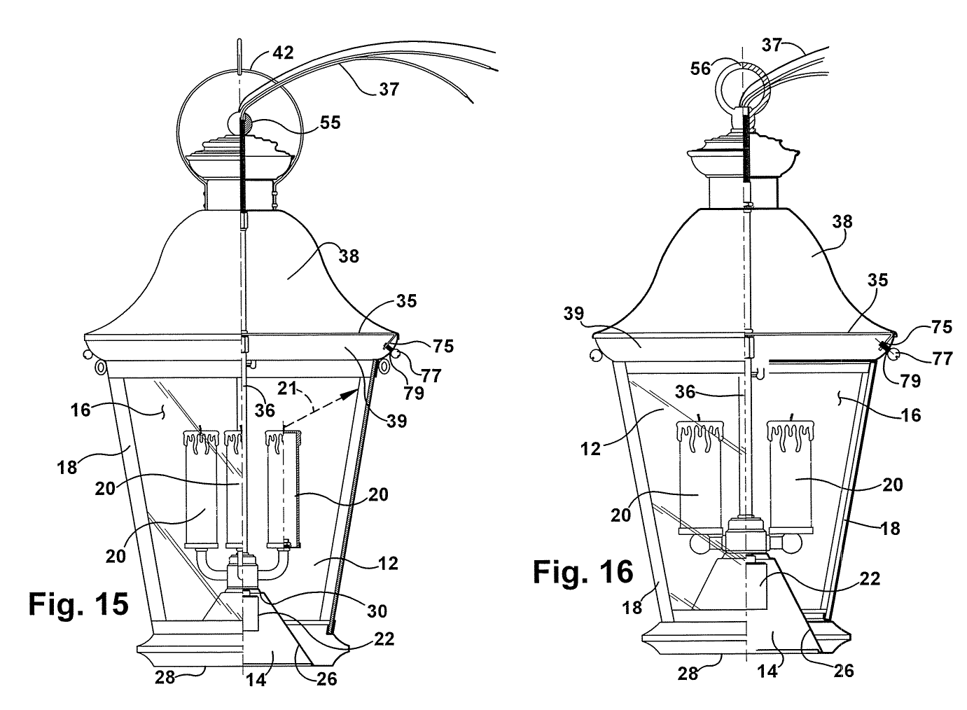

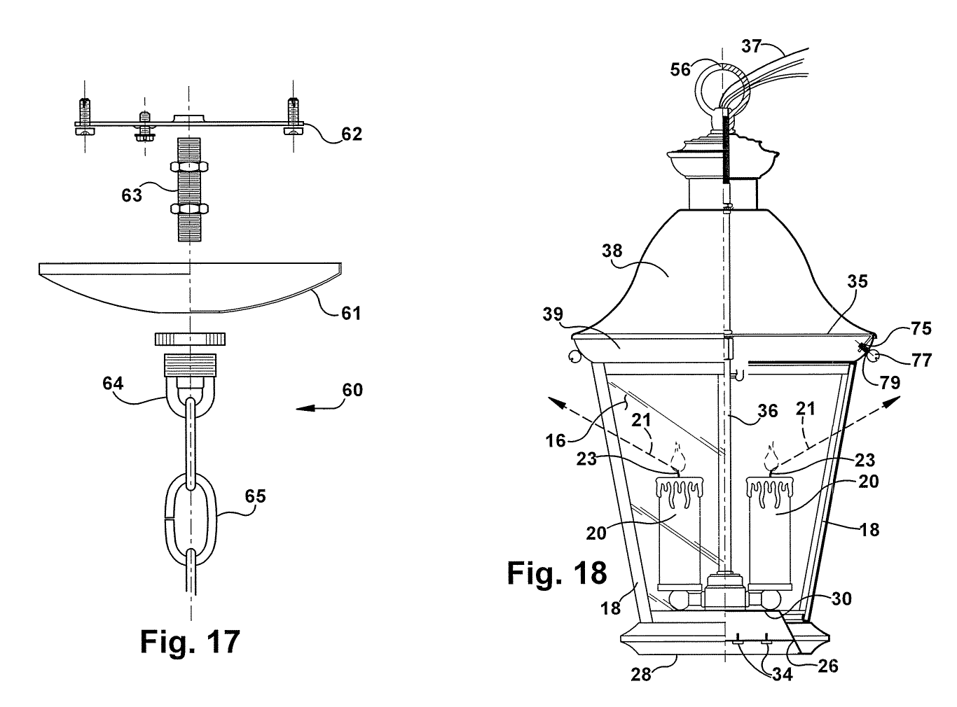

As shown in the embodiments of FIGS. 15 and 16, the fixture 10 may be configured to provide a bottom surface or ceiling mount, as is used with pendant lighting. In these exemplary embodiments, the wiring 37 extends from a decorative finial 55 (see FIG. 15) or loop 56 (see FIG. 16) connected with an upper end of the cap portion 38. The fixture 10 may hang from a ceiling or other such structure by a strap 42 (FIG. 15) or loop 56 (FIG. 16) connected with the cap portion 38, and supported by a canopy assembly, such as the exemplary canopy assembly 60 of FIG. 17, which includes a canopy 61, mounting strap 62, threaded nipple 63, screw collar loop 64, and chain 65.

In order to maintain the aesthetic quality of the lighting fixture 10, it may be desirable to limit the extent to which the lighting chamber 14 extends into the decorative chamber 12. The lighting chamber 14 may, but need not, be configured to extend into the decorative chamber 12 no more than fifty percent of the overall height of the decorative chamber 12 or fifty percent of the portion of the chamber 12 viewable through the glass panels 16. In other embodiments, decorative elements, such as, for example, imitation light sources, may be positioned in the decorative portion of the fixture to partially or fully conceal the extension of the opaque wall into the decorative portion. As one example, the illustrated embodiment of FIGS. 9 and 10 provides imitation light sources 20 that extend from a lower portion of the opaque wall 26 to partially conceal the wall 26 from view. As another example, the illustrated embodiment of FIGS. 11 and 12 provides a imitation light source 20 that completely surrounds and conceals the opaque wall 26. Other decorative elements may also be provided in the decorative chamber 12 to cover, surround, or otherwise conceal the opaque wall or upper end of the lighting portion.

As configured, the exemplary embodiments maintain the aesthetic appeal of a traditional decorative lighting fixture. The lighting chamber 14 may be limited to a low profile and is not intrusive as an observer views the fixture 10. The dominant features remain the imitation light sources 20 or other decorative elements of the decorative chamber 12, and not the actual light source 22. In other embodiments, the lighting fixture may be adapted to use smaller light sources in order to minimize the size of the lighting chamber, resulting in little or no intrusion of the lighting chamber into the decorative chamber. FIG. 18 illustrates one such embodiment, in which light emitting diodes (LED's) 34 are disposed on a horizontal opaque wall 26 in the lighting chamber 14. An LED driver circuit or circuits (not shown) may be provided in the lighting portion of the fixture, or in the cap portion 38 and connected with the LED's 34 by wiring disposed within a central conduit 36, or in another portion of the fixture, or external to the fixture. By minimizing the size of the lighting chamber, the decorative chamber 12 may be further adapted to more closely resemble a traditional lighting fixture, with no extension of the opaque wall 26 visible in the decorative chamber.

While the present invention has been illustrated by the description of embodiments thereof, and while the embodiments have been described in some detail, it is not the intention of the applicant to restrict or in any way limit the scope of the described invention to such detail. Additional advantages and modifications will readily appear to those skilled in the art. For example, the teachings herein may be used with virtually any type of lighting products (fixtures or portables), including without limitation Tiffany style lighting, recessed lighting, track lighting, fan lighting, hospitality lighting, landscape lighting, site lighting, accent lighting, ADA lighting (fixtures for mounting on a wall that extend no more than a specified amount, e.g., 4 inches, from the wall to comply with the Americans with Disabilities Act), architectural lighting, built-in lighting, valance lighting, etc. As another example, the fixtures herein have been characterized as emitting no light above a horizontal plane; the fixtures herein may also be characterized to (and/or modified to) emit no light above different predetermined positions, such as either emitting no light above n° above a horizontal plane, or emitting no light n° below a horizontal plane, e.g., either emitting no light above 5° above a horizontal plane, or emitting no light 5° below a horizontal plane. Additionally, any one or more of the glass panes in the exemplary embodiments may be replaced with an opaque plate. Therefore, the invention in its broader aspects is not limited to the specific details, representative apparatus and methods, and illustrative examples shown and described. Accordingly, departures may be made from such details without departing from the spirit or scope of the applicant's general inventive concept.

What is claimed is:

1. An outdoor lighting fixture, comprising:
a housing;
a light source, disposed in a lower portion of the housing and configured to direct light at least partially downward from the lower portion of the housing;
an opaque wall, positioned in the housing to provide at least a partial upper boundary for the lower portion, wherein the opaque wall prevents light directed from the light source from being emitted outside the housing above a horizontal plane intersecting a lowermost point on the fixture from which light is emitted; and
a decorative ornament, disposed within the housing at least partially above the opaque wall, wherein the decorative ornament is visible from outside the housing.

2. The outdoor lighting fixture of claim 1, wherein the housing comprises an at least partially transparent outer wall through which the decorative ornament is visible.

3. The outdoor lighting fixture of claim 1, wherein at least a portion of the decorative ornament is reflective.

4. The outdoor lighting fixture of claim 1, wherein at least a portion of the opaque wall is frustoconical.

5. The outdoor lighting fixture of claim 1, wherein at least a portion of the opaque wall is reflective.

6. The outdoor lighting fixture of claim 1, wherein the lower portion of the housing defines a transparent bottom surface through which light from the light source is permitted to pass.

7. The outdoor lighting fixture of claim 1, wherein the lower portion of the housing defines a translucent bottom surface through which light from the light source is permitted to pass.

8. The outdoor lighting fixture of claim 1, wherein the light source comprises a light bulb socket.

9. The outdoor lighting fixture of claim 1, wherein the light source comprises at least one light emitting diode.

10. The outdoor lighting fixture of claim 1, further comprising a conduit extending upward from the lower portion of the housing, and electrical wiring at least partially disposed within the conduit for connecting the light source to an external power source.

11. The outdoor lighting fixture of claim 1, wherein the decorative ornament comprises an artificial lighting component.

12. The outdoor lighting fixture of claim 1, wherein the decorative ornament comprises a non-functioning lighting component.

13. The outdoor lighting fixture of claim 12, wherein the non-functioning lighting component is convertible to a functioning lighting component.

14. The outdoor lighting fixture of claim 1, wherein the decorative ornament is at least partially disposed radially between the opaque wall and an outer wall.

15. The outdoor lighting fixture of claim 6, wherein the lighting source is not directly visible when viewing the fixture from above the bottom surface.

16. An outdoor lighting fixture, comprising:
a housing comprising an at least partially transparent outer wall;
a light bulb socket, disposed in a lower portion of the housing and configured to direct light at least partially downward from the lower portion of the housing;
a frustoconical opaque wall, positioned in the housing to provide at least a partial upper boundary for the lower portion of the housing, wherein the opaque wall prevents light directed from the light source from being emitted outside the housing above a horizontal plane intersecting a lowermost point on the fixture from which light is emitted;
a conduit, extending upward from the lower portion of the housing;
electrical wiring at least partially disposed in the conduit for connecting the light bulb socket to an external power source; and
an artificial lighting component, disposed within the housing radially between the opaque wall and the outer wall and at least partially above the opaque wall, wherein the decorative ornament is visible from outside the housing through the at least partially transparent outer wall;
wherein the lower portion of the housing defines a transparent bottom surface through which light from the light source is permitted to pass; and
wherein the light bulb socket is not directly visible when viewing the fixture from above the bottom surface.

17. a decorative ornament, disposed within the housing at least partially above the opaque wall, wherein the decorative ornament is visible from outside the housing.

18. A method for providing decorative outdoor lighting in which light is prevented from being emitted above a horizontal plane running through a lowest point on the fixture from which light is emitted, the method comprising:
providing a lighting fixture comprising a decorative chamber defined by an at least partially transparent outer wall;
providing a light source on the lighting fixture below the decorative chamber;
directing emission of light from the light source at least partially downward through a transparent lateral surface of the fixture;
providing an opaque wall for blocking the emission of light from the light source outside the fixture above a horizontal plane running through a lowest point on the fixture from which light is emitted; and
displaying a decorative ornament within the decorative chamber, wherein the decorative article resembles a lighting component.

19. An outdoor lighting fixture, comprising:
a decorative chamber, comprising an upper end, a lower end, and an at least partially transparent enclosure extending from the upper end to the lower end of the decorative chamber;
a lighting chamber, disposed at least partially below the lower end of the decorative chamber, the lighting chamber comprising an opaque wall separating the lighting chamber from the decorative chamber, and a bottom plane;
at least one imitation light source, disposed in the decorative chamber; and
at least one lighting source, disposed in the lighting chamber and configured to direct light through the bottom surface;
wherein when the at least one lighting source is illuminated, light emitted from the at least one lighting source is not directed outside the lighting fixture above a horizontal plane intersecting a lowest point on the lighting fixture from which light is emitted.

20. The outdoor lighting fixture of claim 19, wherein the opaque wall of the lighting chamber extends above the lower end of the decorative chamber.

21. The outdoor lighting fixture of claim 19, wherein at least a portion of the opaque wall of the second chamber is frustoconical.

22. The outdoor lighting fixture of claim 19, wherein at least a portion of the bottom plane is transparent.

23. The outdoor lighting fixture of claim 19, wherein at least a portion of the bottom plane is translucent.

24. The outdoor lighting fixture of claim 19, wherein the bottom plane is substantially disposed on the horizontal plane.

25. The outdoor lighting fixture of claim 19, wherein at least a portion of an internal surface of the opaque wall is reflective.

26. The outdoor lighting fixture of claim 19, wherein the decorative chamber further comprises an upper opaque surface.

27. The outdoor lighting fixture of claim 26, wherein the upper opaque surface is reflective.

28. The outdoor lighting fixture of claim 19, wherein the at least one lighting source comprises a light bulb socket.

29. The outdoor lighting fixture of claim 19, further comprising electrical wiring extending from the at least one lighting source through the decorative chamber for connecting the at least one lighting source to an external power source.

30. The outdoor lighting fixture of claim 19, wherein the enclosure comprises a plurality of glass panels coupled together by a plurality of frame members.

31. A method for providing decorative outdoor lighting in which light rays are projected below a horizontal plane running through the lowest point on the fixture from which light is emitted, the method comprising:
providing a decorative chamber comprising an at least partially transparent enclosure;
providing a lighting chamber, extending into a bottom end of the decorative chamber;
providing a lighting source in the lighting chamber;
displaying an imitation light source disposed in the decorative chamber such that it is visible through the outer wall;
directing light from the light source through a transparent surface in a bottom plane of the lighting chamber; and
blocking light from the light source such that the light is not directed outside the lighting fixture above the bottom plane.

32. The method of claim 31, further comprising providing a reflective surface in the lighting chamber and reflecting light in the lighting chamber such that the reflected light is directed through the transparent surface.

33. A lighting fixture, comprising:
(a) at least one functioning light source that is shielded in such a manner that light rays emitted by the fixture, either directly from the functioning light source and/or indirectly from the fixture, are not projected above an imaginary horizontal plane running through the lowest point on the fixture where light is emitted; and
(b) at least one non-functioning light source that is visible from outside the fixture from at least one side of the fixture.

34. The lighting fixture of claim 33 wherein the at least one non-functioning light source is configured with respect to the fixture so that, if the at least one non-functioning light source were functioning, the at least one non-functioning light source would cause the fixture, either directly from the light source and/or indirectly from the fixture, to emit light rays above an imaginary horizontal plane running through the lowest point on the fixture where light is emitted.

35. The lighting fixture of claim 33 wherein the at least one non-functioning light source is configured with respect to the fixture so that, if the at least one non-functioning light source were functioning, the at least one non-functioning light source would emit light rays above an imaginary horizontal plane running through the lowest point on the fixture where light is emitted.
